(19) United States
(12) Patent Application Publication
(10) Pub. No.: US 2010/0140843 A1
(43) Pub. Date: Jun. 10, 2010

(54) METHOD FOR THE MANUFACTURE OF A PREFERABLY CROSSLINKED, EXTRUDED POLYMER PRODUCT

(75) Inventor: Werner Kempter, Magrethen (CH)

Correspondence Address: MORRISS OBRYANT COMPAGNI, P.C., 734 EAST 200 SOUTH, SALT LAKE CITY, UT, 84102, US

(73) Assignee: Silon s.r.o. Plano nad Lu'znici, 02 Sezimova Usti 2 (CZ)

(21) Appl. No.: 12/444,570

(22) PCT Filed: Oct. 2, 2007
(86) PCT No.: PCT/CH07/00486

§ 371 Date: Feb. 16, 2010

(30) Foreign Application Priority Data
Oct. 4, 2006 (CH) 1575/06
Jul. 13, 2007 (CH) 1133/07

(51) Int. Cl. B29C 45/00; C08J 3/22

(52) U.S. Cl. 264/328.2; 523/351

(57) ABSTRACT

Disclosed is a method for manufacturing a preferably crosslinked polymer product from a starting polymer. In said method, at least one liquid additive and other additives are metered to the starting polymer and are then processed into the final product in a continuous casting or injection molding device. The additives are first mixed with a suitable supporting material that has a fissured surface or an open cell structure, whereupon the liquid additive is added. Said mixture is then mixed with the basic material and is processed immediately in front of the continuous casting or injection molding device.

### CROSS-REFERENCE TO RELATED APPLICATIONS

This application claims priority to PCT/CH2007/000486 filed on Oct. 2, 2007, CH1575/06 filed on Oct. 4, 2006 and CH 1133/07 filed on Jul. 13, 2007, the entirety of which are incorporated by this reference.

### BACKGROUND OF THE INVENTION

1. Field of the Invention

The invention relates to a method for producing a preferably crosslinked, extruded polymer product from a starting polymer in which a reaction mixture of the starting polymer, at least one liquid reactive reagent and further additives are produced and processed to form the a polymer product in a continuous casting or injection molding device.

2. Prior Art

EP-A-695 320 relates to a method for producing a crosslinked, extruded polymer product, wherein the polymer to be crosslinked is processed with liquid additives through extrusion in a continuous casting device. In the described method according to a preferred method variant only a part of the polymer material to be crosslinked is used as a porous base material. The rest of the material to be crosslinked is used as not fissured material for reasons of cost. The fissured material is mixed with the liquid additive that serves the crosslinking immediately before the processing. This mixture is then mixed directly in the installation with conventional, not fissured material and then processed in the screw-type extrusion machine.

The disadvantage of the method is that not only the liquid additive, but also all further admixtures must be metered at the same time. Furthermore, the producer of the crosslinked polymer product has to order the different original materials (additives, admixtures) from different producers.

A method for the cross-linking of polymers is known from EP-A-651 001 in which, in order to produce crosslinked polymer molded parts, thermoplastic basic polymers in pourable form are mixed with likewise pourable carrier polymers dispersible or soluble in the basic polymer with a cross-linking agent. These mutually compatible components are heated under further mixing to a reaction temperature above the melting range and processed.

In the method described so-called carrier polymers with a porous structure, which have respectively at least one organic peroxide and/or coagent incorporated into the fine porous structure as a fluid silane-free, cross-linking agent, are mixed into the basic polymers.

U.S. Pat. No. 4,783,511 describes a method for the production of extruded bodies from a thermoplastic polyamide, in which polyamide is intensively mixed with a masterbatch and converted to an extruded body in a known manner. The masterbatch comprises a carrier material that has a good absorption capacity for silane, is compatible with the polyamide and does not lead to any deterioration of the product quality. Various methods are proposed for producing the masterbatch: that of a first method the melt of a polyolefin is loaded directly with the silane, extruded as a cord and comminuted to give a granulate which is carefully dried. According to a second method a silane-swellable carrier material is used in the form of grains or a coarse powder, which is brought directly into contact with the silane. The prerequisite for the applicability of this method is that the material (masterbatch) is still sprayable. With this method, in general more than 20% by weight silane is added to the carrier material. According to a third method, a thermoplastic in the form of a sponge with open pores, but which has no swellability with silane, is used. The open-pore carrier materials have the property that they can be loaded with a quantity of silane that corresponds to a multiple of the dead weight of the carrier material. The disadvantage of the third method is the relatively high cost of the production of the microporous polymer system.

The method of U.S. Pat. No. 4,783,511 has the disadvantage that the expenditure to produce the masterbatch is relatively high. Moreover, the masterbatch must be processed while excluding air and moisture, which makes the handling more difficult. Furthermore, there is a risk that the masterbatch will absorb moisture despite all precautionary measures, which reduces the product quality.

GB-A-2 170 206 describes a method for producing a crosslinked polymer product, in which a crosslinkable base material comprising a thermoplastic or elastomeric material as a free flowing powder or granular flow is wetted with silane at room temperature. Following the wetting of the free flowing particles of the base material with at least the silane, a free flowing flow of a masterbatch, which contains additives, such as pigments, carbon black, stabilizers and fillers, is added. Since according to experience the base material has only an inadequate absorption capacity for silane, a constant quality is difficult to maintain.

### OBJECT OF THE INVENTION

The object of the present invention is to provide a method with which the expenditure for the metering of the liquid reagent and the additives is reduced. Another object is to achieve the best possible intermixing of all of the original materials, so that the quality of the finished product is as high as possible.

### DETAILED DESCRIPTION OF THE INVENTION

According to the invention, the object is attained through a method in that a polymer granulate or polymer powder acting as a carrier material is processed with the additives to form a mixture with fissured surface or open-pore structure, hereinafter called the masterbatch, and that the masterbatch is processed with the polymer (=base material) to be processed and the liquid reagent in the continuous casting or injection molding device to form the polymer product. This method has the advantage that the production of the polymer product is greatly simplified because the masterbatch thus provided at the same time has a good absorption capacity for the liquid reagent. Accordingly, a smaller number of components need to be metered with the actual processing. In particular, the method also has the advantage that the producer of the polymer product no longer needs to separately purchase and meter the additives, because they are already contained in the prefabricated mixture. In contrast to the present invention, in GB-A-2 170 206 cited at the outset, the silane is added to the base material and not to the masterbatch. Furthermore, the carrier material of the masterbatch does not have a fissured or open-pore surface.

Advantageously, the carrier material is processed with the liquid reagent and the additives to form a masterbatch with open-pore or fissured surface and then metered on the continuous casting or injection molding device—like the base material—and processed with the base material. This has the advantage that all of the added components are mixed homogenously with the base material, whereby a constant quality of the finished polymer product is guaranteed. Furthermore, the material with open-pore or fissured surface ensures a good distribution of the liquid reagent. It is also conceivable to process the carrier material with the additives and the liquid reagent to form a masterbatch with open-pore or fissured surface and then to directly meter it on the continuous casting or injection molding device—like the base material—and to process it with the base material. This method has the advantage that the masterbatch contains the additives as well as the reactive reagent. Preferably the reaction mixture is additionally mixed before the entry into the continuous casting or injection molding device. This has the advantage that the reaction mixture to be processed in the continuous casting or injection molding device is homogenous.

Expediently, in addition components such as stabilizers, fillers, slip agents, reinforcing substances, catalysts, processing aids, etc., are used as additives. For example, antioxidants, light-stability agents and/or heat-stability agents are used as stabilizers. Acid amides, fatty acid esters, fatty alcohols, metallic soaps, silicone derivatives and/or fluorine compounds are often used as slip agents and processing aids. Color pigments and/or inorganic pigments are possible as further additives.

Advantageously, a maximum of 25% by weight, preferably a maximum of 12, and very particularly preferably a maximum of 5% by weight of the carrier material with fissured surface or open-pore structure is used. Through the use of only a small amount of the expensive polymer granulate or polymer powder with fissured surface or open-pore structure, the costs for the production of the crosslinked polymer product can be kept low. Depending on the absorptive capacity or wettability of the carrier material and depending on the amount of the liquid to be added and the desired dispersibility of the additives, more or less carrier material is used in the formulation.

Expediently, the carrier material is produced from the same polymer as the polymer to be crosslinked. However, it is likewise conceivable that the carrier material is produced from a chemically different polymer from the polymer to be crosslinked. In both cases the polymers comprise respectively unsaturated hydrocarbons such as polyethylene (PP and HDPE), polypropylene, polyamide, and the like. This results in further possibilities in the production of the crosslinked polymer product when, for example, the carrier material has a different reactivity from the base material.

Expediently, the carrier material is produced from the same polymer as the base material. It has surprisingly been established in tests that the finished polymer product in general is crosslinked to a higher percentage than when base material and carrier material are produced from different starting polymers. Depending on the use, however, it can also be useful when the carrier material and base material are made from chemically different polymers.

Advantageously, the carrier material with fissured surface or open-pore structure without additives has a bulk density between approximately 0.1 and 0.55 g/cm3. Stabilizers, fillers, reinforcing substances, catalysts, processing aids, such as slip agents, etc., can be used as additives.

Particularly advantageously the method can be used when the liquid reagent is a reactive compound, which can serve the crosslinking of the polymer. With reactive processes, an optimal distribution of the components for the finished product is of great importance. For example, silane or mixtures of silane and other compounds can be used as a liquid reagent. Silane is used, for example, in order to crosslink unsaturated polymers.

The additives used in the method are used to influence properties of the finished polymer product such as conductivity, flame resistance, abrasion resistance, structural behavior, colors etc.

It has been shown that it is a great advantage for the manufacturing industry when the first mixture can be produced at a distance from the screw-type extrusion machine or continuous casting device and the user is provided with at least the additional components mixed with the carrier material as a finished mixture. This facilitates handling considerably. Advantageously, the fissured or open-pore material is produced mechanically. However, it is also conceivable to produce the fissured or open-pore material by foaming.

A mixing device, such as can be used for metering a liquid additive, is disclosed, for example, in WO 2006/010291, the content of which is incorporated by reference herein. The mixing device permits the continuous or intermittent metering of a liquid additive to a bulk material (granulate or powder). In this case, the plastics pellets or plastics powder used as carrier material is one with fissured surface or open-pore structure. The fissured surface (enlarged surface) ensures a large absorption capacity for the liquid. An open-pore structure produces a great absorptive capacity of the material. The quantity of the carrier material for the auxiliary agents is in general selected such that an optimal intermixing and absorptive capacity for the liquid additive is ensured. As a rule, the total amount of the carrier material provided with auxiliary agents and additives will be in the range between 3 and 15, preferably 3 and 12% by weight based on the total weight of the finished product. After the metering of the liquid additive, the carrier material provided with the additives is mixed with the base material and extruded.

In the method according to the invention, at least the additives are mixed with a polymer and processed in a mill or an extruder to form a carrier material with fissured or open-pore surface. The carrier material containing the additives thus has at the same time a good absorptive capacity for a liquid additive, such as, e.g., silane.

Preferably, therefore, the carrier material to which the additives have been added is first mechanically fissured or foamed in a manner known to one skilled in the art. Subsequently, the fissured or open-pore carrier material is mixed with the base material and the liquid reagent is metered. The resulting reaction mixture is then preferably mixed once again in a mixer before it is placed in the continuous casting or injection molding device.

It is conceivable to meter the liquid reagent first to the carrier material and to mix the resulting mixture with the base material.

With a method for producing a preferably crosslinked polymer product of a starting polymer at least one liquid additive (reagent) and further additives are metered and subsequently processed to form the finished product in a continuous casting or injection molding device. First the additives are thereby mixed with a suitable carrier material with fissured surface or open-pore structure and a masterbatch produced. The masterbatch is then mixed with the base material and the liquid additive is added. It is conceivable to meter the liquid additive to the masterbatch and to mix this mixture with the base material. The reaction mixture thus produced is processed to form the desired product in the continuous casting or injection molding device.

1. A method for producing a polymer product, comprising:
providing a reaction mixture of a starting polymer,
at least one liquid reactive reagent and additives and;
processing a polymer granulate or polymer powder acting as a carrier material with the additives to form a mixture with a fissured surface or open-pore structure to form a masterbatch; and
processing that the masterbatch with the starter polymer and the at least one liquid reactive reagent in a continuous casting or injection molding device to form a polymer product.

2. The method of claim 1, further comprising processing the carrier material beforehand with the additives to form a silane-free masterbatch with open-pore or fissured surface and metering the silane-free masterbatch directly on the continuous casting or injection molding device.

3. The method of claim 1, wherein the carrier material with the liquid reagent and the additives is processed to form a masterbatch with open-pore or fissured surface, and directly metering the masterbatch on the continuous casting or injection molding device and processing the masterbatch with the starting polymer.

4. The method of claim 1, further comprising mixing the reaction mixture before the entry into the continuous casting or injection molding device.

5. The method of claim 1, further comprising using a maximum of 25% by weight of the masterbatch with fissured surface or open-pore structure.

6. The method of claim 1, further comprising producing the carrier material from the same polymer as the base material.

7. The method of claim 1, further comprising producing the carrier material and base material from chemically different polymers.

8. The method of claim 1, further comprising providing the carrier material with fissured surface or open-pore structure without additives with a bulk density of between approximately 0.1 and 0.55 g/cm3.

9. The method of claim 1, further comprising using at least one of a stabilizer, a filler, a reinforcing substance a catalyst and a processing aid as an additive.

10. The method of claim 1, further comprising using silane as the at least one liquid reactive reagent.

11. The method of claim 1, further comprising using the additives to influence at least one property including conductivity, flame resistance, abrasion resistance, structural behavior and color of the finished polymer product.

12. The method of claim 1, further comprising producing a finished mixture comprised of the carrier material and additives at a distance from a screw-type extrusion machine and providing the finished mixture to a user.

13. The method of claim 1, wherein the processing comprises forming a crosslinked extruded polymer product.

14. The method of claim 1, further comprising mechanically forming the fissured or open-pore material.

15. The method of claim 1, further comprising forming the fissured or open-pore material by foaming.

16. The method of claim 1 further comprising using a maximum of 12% by weight of the masterbatch.

17. The method of claim 1 further comprising using a maximum of 5% by weight of the masterbatch.
